(19) United States
(12) Patent Application Publication
(10) Pub. No.: US 2013/0137308 A1
(43) Pub. Date: May 30, 2013

(54) BOARD-TO-BOARD CONNECTOR

(71) Applicants: Chih-hsien Chiang, New Taipei (TW); Sheng-yuan Huang, New Taipei (TW); Sheng-nan Yu, New Taipei (TW)

(72) Inventors: Chih-hsien Chiang, New Taipei (TW); Sheng-yuan Huang, New Taipei (TW); Sheng-nan Yu, New Taipei (TW)

(73) Assignee: Cheng Uei Precision Industry Co., LTD., New Taipei (TW)

(21) Appl. No.: 13/304,408

(22) Filed: Nov. 25, 2011

(51) Int. Cl. H01R 24/28

(52) U.S. Cl. 439/660

(57) ABSTRACT

Provided is a board-to-board connector, including a male connector and a female connector. The male connector includes a male housing and a plurality of male terminals. Each male terminal has a U-shaped plug portion. The female connector includes a female housing and a plurality of female terminals. Each female terminal has a first contact portion, a second contact portion and an inserting space. When the male and female terminals are engaged with each other, the flexible end of the male terminal is engaged with the rigid end of the female terminal, and the rigid end of the male terminal is engaged with the flexible end of the female terminal. Accordingly, the male and female terminals are engaged together by combining the rigid with the flexible so that avoiding resulting in the deformation and the damage of the terminals, and further assuring the performance of the board-to-board connector.

### BACKGROUND OF THE INVENTION

1. Field of the Invention

The present invention relates to a connector, and more particularly to a double-contact board-to-board connector being capable of preventing the deformation of the terminals or the damage of the contacting portions.

2. Description of the Prior Art

A connector is widely used in a network communicate device and is mounted on a circuit board. There can form the communication transmission between the connector and the circuit board by the terminals of the connector, so that realizing the date transmission.

The prior board-to-board connector consists of a male connector and a female connector. The male connector comprises a male housing and a plurality of male terminals received in the male housing. The female connector comprises a female housing and a plurality of female terminals received in the female housing. One ends of the male terminal and the female terminal are respectively connected to two circuit boards, and the other ends thereof are connected to each other, thereby realizing an electrical connection of the male connector and the female connector and finally realizing an electrical connection of the two circuit boards.

To ensure the performance of the whole connector formed by the male and female connectors being connected to each other, the engagement of the male and female terminals is a hard interference fit with rigid-to-rigid. This hard interference fit easily results in the deformation of the male and female terminals or the damage of the contacting portions thereof. Therefore, in the prior art, the male and female terminals cannot well contact with each other so that affecting the performance of the connector.

Hence, it needs to provide a connector, which can prevent the deformation of the terminal or the damage of the contacting portions, to overcome the defect of the prior connector, thereby assuring the performance of the connector.

### BRIEF SUMMARY OF THE INVENTION

For solving the problem in the above prior art, an object of the present invention is to provide a double-contact board-to-board connector, which can efficiently preventing the deformation of the terminals or the damage of the contacting portions between the terminals, so that assuring the performance of the board-to-board connector.

To achieve the above object, in accordance with the present invention, a board-to-board connector is provided, comprising a male connector and a female connector connected together. The male connector comprises a male housing forming a plurality of male terminal grooves, and a plurality of male terminals, each of which has a U-shaped plug portion. The male terminals are formed in the corresponding male terminal grooves, and the plug portion of each male terminal is retained in the male housing. The female connector comprises a female housing forming a plurality of female terminal grooves, and a plurality of female terminals, each of which has a first contact portion, a second contact portion and an inserting space formed between the first and second contact portions. The female terminals are accommodated in the corresponding female terminal grooves, and the first contact portion, the second contact portion and the inserting space of each female terminal are exposed out of the female housing. Wherein the male housing and the female housing are engaged with each other, the plug portion of each male terminal is inserted into the inserting space of the corresponding female terminal, and both the first and second contact portions of the female terminal contact with the plug portion of the male terminal.

Based on the above description, the board-to-board connector of the present invention employs the male terminal having the U-shaped plug portion and the female terminal having the first contact portion, the second contact portion and the inserting space formed between the first and second contact portions. When the male terminal and the female terminal are engaged with each other, the plug portion of the male terminal is inserted into the inserting space of the female terminal, the first and second contact portion contact with the plug portion. Namely, the flexible end of the male terminal is engaged with the rigid end of the female terminal, and the rigid end of the male terminal is engaged with the flexible end of the female terminal. Accordingly, the male terminal and the female terminal are engaged together by the way of combining the rigid with the flexible. Compared with the prior engagement of the hard interference fit, the present invention can avoid resulting in the deformation of the male terminal and the female terminal and the damage of the contact portions of the both, so that assuring the performance of the board-to-board connector.

### BRIEF DESCRIPTION OF THE DRAWINGS

FIG. 1 is a structure schematic view of a board-to-board connector of the present invention.

FIG. 2 is an exploded view from the top surface of a male housing of the board-to-board connector of the present invention.

FIG. 3 is an exploded view from the bottom surface of a female housing of the board-to-board connector of the present invention.

FIG. 4 is a structure schematic view of a male terminal of FIG. 2.

FIG. 5 is a structure schematic view of a female terminal of FIG. 2.

FIG. 6 is a schematic view of an engagement state of the male terminal and the female terminal.

### DETAILED DESCRIPTION OF THE PREFERRED EMBODIMENTS

The following embodiment with reference to the accompanying drawings now has been given for detail describing the technology, the feature, the object and the effect of the present invention.

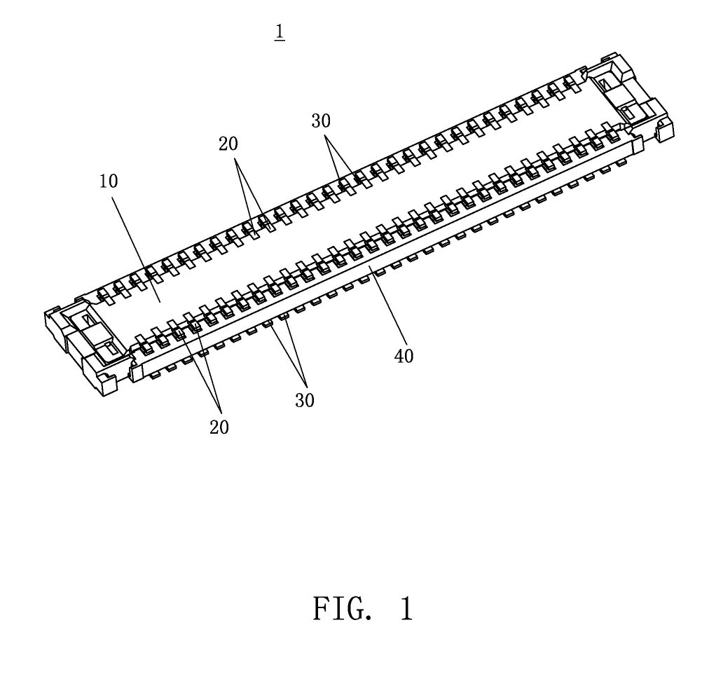

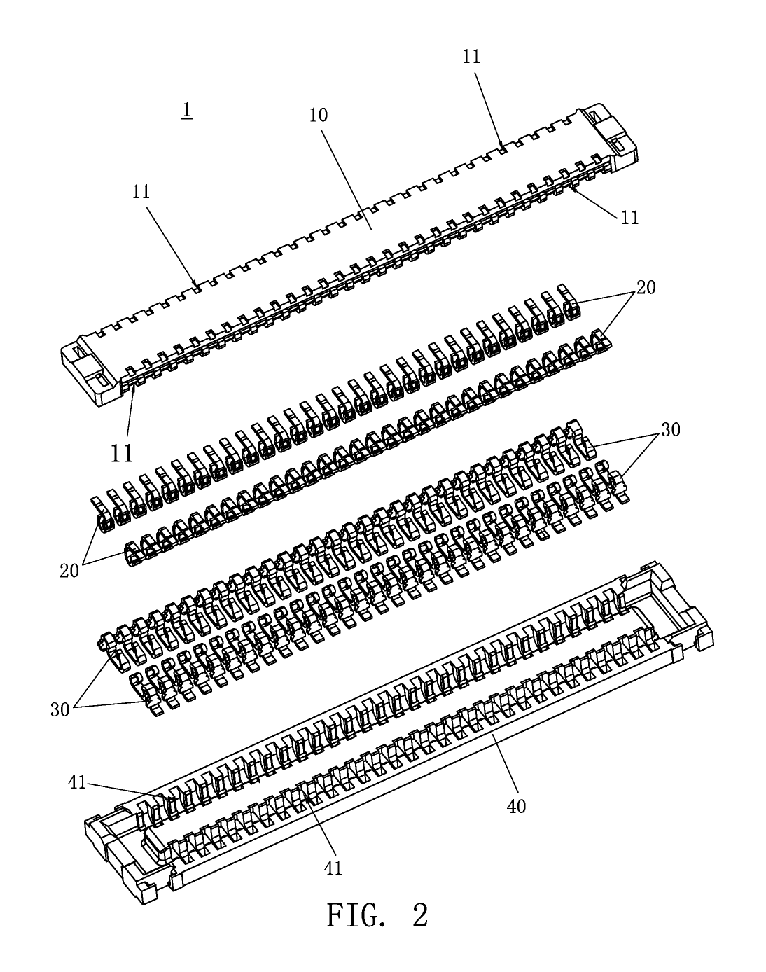

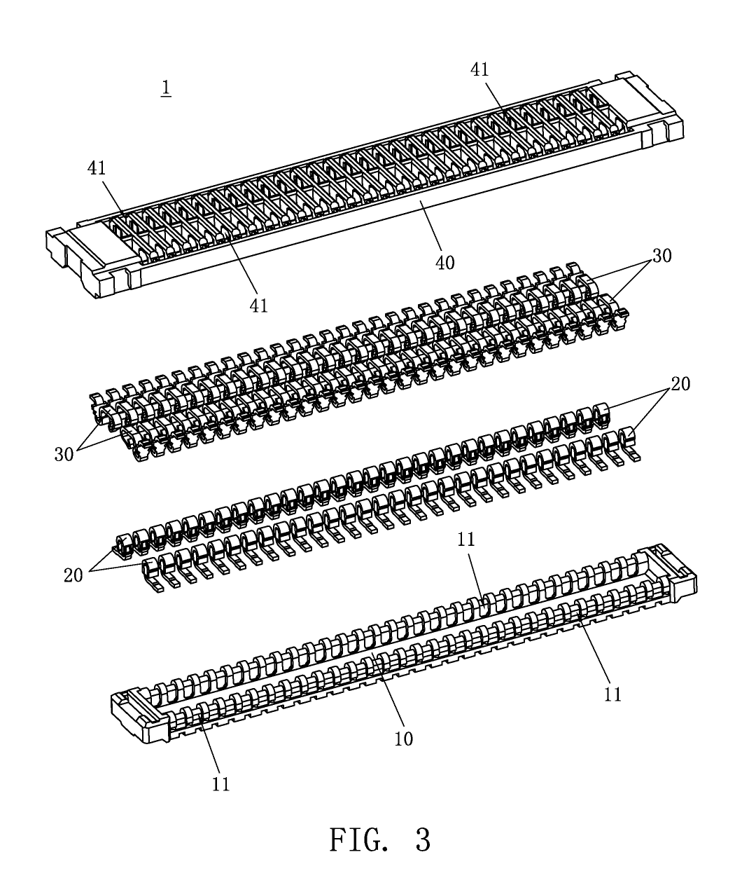

Please refer to FIGS. 1 to 3, a board-to-board connector 1 of the present invention comprises a male connector and a female connector connected together. The male connector comprises a male housing 10 and a plurality of male terminals 20. The female connector comprises a female housing 40 and a plurality of female terminals 30. The male housing 10 forms a plurality of male terminal grooves 11 corresponding to the male terminals 20. The male terminals 20 are respectively accommodated in the male terminal grooves 11 and are fixed in the male housing 10. The female housing 40 forms a plurality of female terminal grooves 41 corresponding to the female terminals 30. The female terminals 30 are respectively accommodated in the female terminal grooves 41. The male housing 10 and the female housing 40 are complementary connected to each other, and the male terminals 20 and the female terminals 30 are engaged with each other.

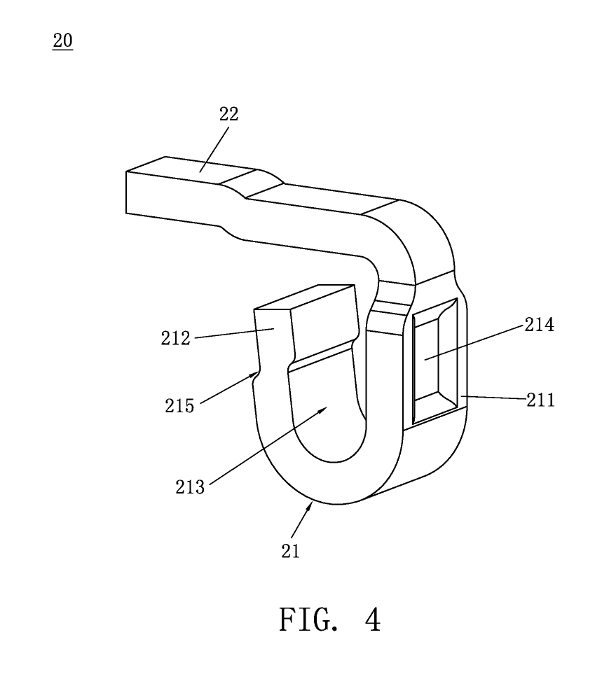

Please refer to FIG. 4, each of the male terminals 20 has a plug portion 21 being U-shaped and a first solder portion 22. The plug portion 21 includes a first contact section 211 and a second contact section 212, which face each other. There forms a holding space 213 between the first contact section 211 and the second contact section 212. The first solder portion 22 is formed by being bent and extending from an end of the first contact section 211 toward the second contact section 212. The first contact section 211 also defines a recess 214, and the second contact section 212 forms a shoulder 215. The second contact section 212 is a flexible end. Oppositely, the first contact section 211 is a rigid end. After the male terminal 20 is held in the male housing 10, one end of the second contact section 212 is bent twice to form the flexible end by a tool, so that the male housing 10 is being retained in the holding space 213 and the first solder portion 22 is extending out of the male housing 10.

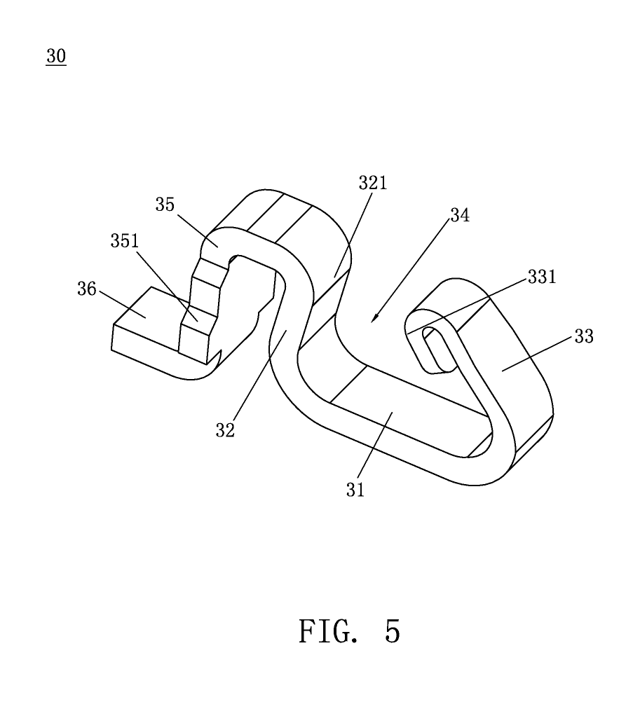

Please refer to FIG. 5, each of the female terminals 30 has a base portion 31, a first contact end 32 and a second contact end 33. The first and second contact ends 32, 33 are bent upward from the base portion 31 and tiltedly extend face to face. There forms an inserting space 34 between the first contact end 32 and the second contact end 33. The first contact end 32 protrudes toward the inserting space 34 to form a first contact portion 321, and a free end of the second contact end 33 is curled and bent toward the inserting space 34 to form a second contact portion 331. Therefore, the second contact portion 331 is a flexible end, and oppositely, the first contact portion 321 is a rigid end. Moreover, there forms a block portion 35, which is bent and extends outward from an end portion of the first contact end 32. The block portion 35 faces the first contact end 32. There also forms a second solder portion 36, which is bent and extends outward from a free end of the block portion 35. The second solder portion 36 and the base 31 are generally located on one same horizontal position. Preferably, there forms a protrusion 351 on two sides of the block portion 35. The protrusion 351 is step-shaped. When the female terminal 30 is mounted on the female housing 40, the female terminal 30 is accommodated in the female terminal groove 41 of the female housing 40. Wherein the first contact portion 321, the second contact portion 331 and the inserting space 34 are exposed out of the female housing 40, and the second solder portion 36 protrudes from one side of the female housing 40. After the female housing 40 and the male housing 10 are engaged with each other, the plug portion 21 of the male terminal 20 is inserted into the inserting space 34, the first contact portion 321 leans on the shoulder 215 of the second contact section 212, and the second contact portion 331 contacts with the recess 214 of the first contact section 211.

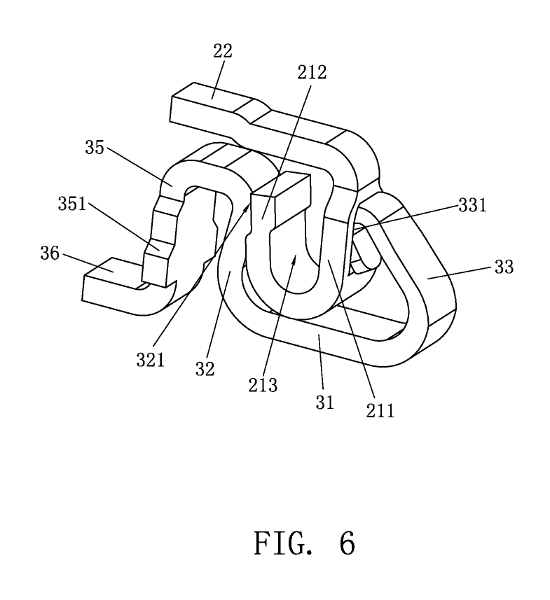

Please refer to FIGS. 1 to 6, the mounting process of the board-to-board connector 1 of the present invention will be described as follows.

First, the male terminals 20 are formed in the male terminal grooves 11 of the male housing 10, the first contact section 211 is located on the inside of the male housing 10, and second contact section 212 and the first solder portion 22 extend out of the male housing 10. Then, the second contact section 212 is bent twice to form a flexible end, and the male housing 10 is retained in the holding space 213 defined between the first contact section 211 and the second contact section 212, so that the first and second contact sections 211, 212 form a U-shaped plug portion 21. Correspondingly, the female terminals 30 are accommodated in the female terminal grooves 41 of the female housing 40, and the second solder portion 36 protrudes out of the side of the female housing 40. Then, the male housing 10 is engaged with the female housing 40. At the same time, the male terminals 20 correspondingly contact with the female terminals 30. Namely, the male terminals 20 are inserted into the inserting spaces 34 of the female terminals 30, the first contact section 211 of each male terminal 20 contacts with the second contact portion 331 of the corresponding female terminal 30, and the second contact section 212 of each male terminal 20 contacts with the first contact portion 321 of the corresponding female terminal 30, thereby making the male terminals 20 to be engaged with the female terminals 30.

As described above, the board-to-board connector 1 of the present invention comprises the male housing 10, a plurality of male terminals 20, the female housing 40 and a plurality of female terminals 30. Each male terminal 20 has a U-shaped plug portion 21. The plug portion 21 includes the first and second contact sections 211, 212 facing each other. The second contact section 212 is a flexible end. Each female terminal 30 has the first and second contact portions 321, 331 facing each other, and forms the inserting space 34 between the first and second contact portions 321, 331. The second contact portion 331 is also a flexible end. When the male terminals 20 are connected to the female terminals 30, the plug portion 21 of each male terminal 20 is inserted into the inserting space 34 of the corresponding female terminal 30, the first contact section 211 of the male terminal 20 contacts with the second contact portion 331 of the female terminal 30, and the second contact section 222 of the male terminal 20 contacts with first contact portion 321 of the female terminal 30. Namely, the flexible end of the male terminal 20 contacts with the rigid end of the female terminal 30, and the rigid end of the male terminal 20 contacts with the flexible end of the female terminal 30. Accordingly, the male terminal 20 and the female terminal 30 are engaged together by the way of combining the rigid with the flexible. Compared with the prior engagement of the hard interference fit, the present invention can avoid resulting in the deformation of the male terminal 20 and the female terminal 30 and the damage of the contact portions of the both, so that assuring the performance of the board-to-board connector 1.

What is claimed is:

1. A board-to-board connector, comprising a male connector and a female connector connected together;
the male connector comprising:
a male housing forming a plurality of male terminal grooves; and
a plurality of male terminals, each of which has a U-shaped plug portion, the male terminals being formed in the corresponding male terminal grooves, and the plug portion of each male terminal being retained in the male housing; and
the female connector comprising:
a female housing forming a plurality of female terminal grooves; and
a plurality of female terminals, each of which has a first contact portion, a second contact portion and an inserting space formed between the first and second contact portions, the female terminals being accommodated in the corresponding female terminal grooves, and the first contact portion, the second contact portion and the inserting space of each female terminal being exposed out of the female housing;
wherein, the male housing and the female housing being engaged with each other, the plug portion of each male terminal being inserted into the inserting space of the corresponding female terminal, and both the first and second contact portions of the female terminal contacting with the plug portion of the male terminal.

2. The board-to-board connector as claimed in claim 1, wherein the plug poriton of each male terminal includes a first contact section, a second contact section facing the first contact section and a holding space formed between the first and second contact sections; each male terminal further forms a frsit solder portion being bent and extending from an end of the first contact section toward the second contact section; the male terminals are formed in the corresponding male terminal grooves; the male housing is retained in the holding space of each male terminal; and the first solder portion of each male terminal extends out of the male housing.

3. The board-to-board connector as claimed in claim 2, wherein the first contact section of each male terminal forms a recess.

4. The board-to-board connector as claimed in claim 2, wherein each female terminal has a base portion, a first contact end and a second contact end; the first and second contact ends are bent upward from the base portion and tiltedly extend face to face; the first contact portion is formed by protruding toward the inserting space from the first contact end; the second contact portion is formed by curling and bending a free end of the second contact end toward the inserting space; each female terminal further has a second solder portion being bent and extending from a free end of the first contact portion; the plug portion of the male terminal is inserted into the inserting space of the female terminal; the first contact section of the male terminal contacts with the second contact portion of the female terminal; and the second contact section of the male terminal contacts with the first contact portion of the female terminal.

5. The board-to-board connector as claimed in claim 4, wherein each female terminal further has a block portion being bent and extending outward from an end portion of the first contact end; the block portion faces the first contact end; the block portion forms a protrusion on two sides thereof; and the second solder portion is formed by being bent and extending outward from a free end of the block portion.

6. The board-to-board connector as claimed in claim 5, wherein the protrusion is step-shaped.
